(19) United States
(12) Patent Application Publication
(10) Pub. No.: US 2009/0007492 A1
(43) Pub. Date: Jan. 8, 2009

(54) Seals and Fastners

(76) Inventors: Dickory Rudduck, Chicago, IL (US); Lee David Blattmann, Wilmette, IL (US)

Correspondence Address: TELEZYGOLOGY, INC., 520 W. ERIE STREET, SUITE 210, CHICAGO, IL, 60654, US

(21) Appl. No.: 11/910,576

(22) PCT Filed: Apr. 4, 2006
(86) PCT No.: PCT/AU06/00441

§ 371 Date: Oct. 3, 2007

(30) Foreign Application Priority Data
Apr. 4, 2005 (AU) 2005901641

(51) Int. Cl. E06B 7/28

(52) U.S. Cl. 49/316

(57) ABSTRACT

The invention relates to a releasable fastening system (10) including a tongue (20) moveable along a first path between a locking position and an unlocking position, and a shuttle (24) moveable along a second path at an angle to the first path. The shuttle (24) is adapted to be moved along the second path by a material adapted to contract when activated. The releasable fastening system (10) also includes a means linking the tongue (20) and the shuttle (24) such that movement of the shuttle (24) along the second path is adapted to cause movement of the tongue (20) along the first path. The invention further relates to a releasable fastening system (50) for releasably fastening a first element (44) to a second element (46). The releasable fastening system (50) includes a first fastening means (56) for the first element (44) and a second fastening means (62, 66) for the second element (46). The second fastening means (62, 66) is movable along a first path between a locking position in which the second fastening means (62, 66) engages the first fastening means (56) and an unlocking position in which the second fastening means (62, 66) is disengaged from the first fastening means (56). The releasable fastening system (50) also includes a shuttle (64) movable along a second path at an angle to the first path, and a means linking the second fastening means (62, 66) and the shuttle (64) such that movement of the shuttle (64) along the second path is adapted to cause movement of the second fastening means (62, 66) along the first path. The releasable fastening system (10 or 50) may include a strain reduction assembly.

### FIELD OF THE INVENTION

This invention relates to seals and fasteners. For convenience, the invention in its various aspects is described below in relation to fastening or sealing of panels, hatches or doors or other elements to aircraft; however, it is to be understood that the invention is not limited to this application.

### BACKGROUND OF THE INVENTION

The invention is concerned with improvements in the current method of fastening panels or other elements to aircraft, Conventionally, aircraft panels are held in place by counter-sunk screws which may then have their heads sealed to minimise radar detection. When a panel or other element of the aircraft needs to be removed for some reason, for example for access, the screws and the sealant must be removed and then replaced when the panel or other element is replaced. Clearly, it is very time consuming to replace and reseal elements in this way.

Further, the nature of the screws currently used can provide for an unsatisfactory seal of the aircraft against ingress of foreign material. Even more importantly, the current arrangement may be unsatisfactory with respect to radar detection.

At present, a large number of screws is required in order to secure panels or other elements of the aircraft, because the screws are small and can secure only small sections of a panel at a time. Further, the nature of the screws is such that the seal produced between one panel and another may be unsatisfactory.

It is an object of the present invention, at least in some embodiments, to reduce the time and effort required to fasten panels or other elements of aircraft in place. It is another object of the invention, at least in some embodiments, to improve the seal that may be achieved between panels or other elements, one to another or between those elements and frames or other underlying structures.

It is a further object of this invention, in a particularly preferred embodiment, to provide improvements in the manner of fastening and sealing elements such as hatches and doors to aircraft.

### DISCLOSURE OF THE INVENTION

In aspects of the invention discussed below, reference is made to material adapted to contract when activated.

The material adapted to contract when activated is preferably shape memory alloy wire. Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various aspects of the present invention, the shape memory alloy contracts when heated in situ. Shape memory alloy wire currently available, such as that sold under the name Nitinol, is capable of contracting by about 3% when activated by heating.

Activation of the material adapted to contract when activated is preferably achieved through electrical resistance heating, with a wire feed to the assembly. Activation of the shape memory alloy wire can be initiated from a central location, using the wiring system of, for example, the aircraft. Power may be supplied by batteries or by induction or any other suitable means. It is within the scope of this invention that the activation is initiated by remote means, such as a hand held tool operating through the use of any suitable form of energy, including microwave, magnetic, electro-magnetic, sonic, infra-red, radio frequency and so on.

The scope of the invention in its various aspects is not necessarily limited to the use of shape memory alloy. Other material may also be useful. Also, while activation may take place through heating, other means of activation may be suitable and are within the scope of this invention.

Accordingly, in a first aspect, the invention provides a releasable fastening system including:
a tongue moveable along a first path between a locking position and an unlocking position;
a shuttle moveable along a second path at an angle to the first path, the shuttle being adapted to be moved along the second path by material adapted to contract when activated; and
means linking the tongue and the shuttle such that movement of the shuttle along the second path is adapted to cause movement of the tongue along the first path.

In a preferred embodiment, the tongue is made of Nylon or similar suitable material. Preferably, the shuttle is made of Nylon or Acetal or another suitable material.

The material adapted to contract when activated is preferably shape memory alloy wire, as discussed above.

The linking means is preferably an extension from the shuttle, the extension being perpendicular to the second path. In this embodiment, the extension is designed to fit into a corresponding cut out in the tongue and to be sliceable therein. The tongue is preferably constrained by guide pins in diagonal slots to move at an angle of approximately 45° to the second path.

The releasable fastening system of a first aspect of the invention is particularly suitable for use as a “horizontal” fastener as illustrated in FIGS. 1 and 2 of the drawings, discussed below. The invention in the second aspect deals with a releasable fastening system which is particularly suitable for use as a “vertical” fastener and this is illustrated in FIGS. 3, 4 and 5, discussed below. It is to be understood, however, that the invention in the first aspect is not limited to “horizontal” fastening systems and the invention in the second aspect is not limited to “vertical” fastening systems.

In the second aspect, the invention provides a releasable fastening system for releasably fastening a first element to a second element, the releasable fastening system including:
a first fastening means for the first element;
a second fastening means for the second element, the second fastening means being movable along a first path between a locking position in which the second fastening means engages the first fastening means and an unlocking position in which the second fastening means is disengaged from the first fastening means;
a shuttle movable along a second path at an angle to the first path; and
means linking the second fastening means and the shuttle such that movement of the shuttle along the second path is adapted to cause movement of the second fastening means along the first path.

In a preferred embodiment, the first element is a panel or door and the second element is a rib, for example, an aircraft rib. The first fastening means is preferably attached to the first element by adhesive or in another suitable manner. The second fastening means may be attached to the second element or it may be formed integrally with it, especially if the second element is an aircraft rib.

It is preferred that the shuttle is adapted to be moved along the second path by material adapted to contact when activated, preferably shape memory alloy wire, as discussed above. However, the invention is not limited to this embodiment. Many types of ‘push-pull’ actuators may be suitable.

The second fastening means preferably includes a lifting bar, constrained to move along the first path by one or more guide pins in diagonal lifting slots. The first path is preferably at an angle of about 45° to the second path. Horizontal movement of the shuttle may in effect cause vertical movement of the second fastening means towards or away from the first fastening means.

The linking means is preferably an extension from the shuttle, the extension being perpendicular to the second path. In this embodiment, the extension is designed to fit into a corresponding cut out in the tongue and to be sliceable therein.

It is further preferred that the second fastening means includes a seal which, together with the first fastening means, is capable of hermetically sealing the fastening system. The fact that the fastening system of the invention can be hermetically sealed can lead to a wide range of applications, not only for panels, doors and hatches but also for liquid or air-sensitive environments, such as air conditioners or in apparatus where lubricants are required.

The releasable fastening system of the second aspect of the invention may be discrete or continuous. In the case of a continuous releasable fastening system, it is preferred that the fastening system includes, as part of the second fastening means, a slip joint. This can permit the releasable fastening system of the invention to follow a non-linear configuration, for example to bend around angles of doors. An example is illustrated in the drawings below.

In relation to both aspects of the invention, it is preferred that the fastening system includes means for protecting the material adapted to contact when activated from damage.

Material such as Nitinol is rated according to its composition. For example, a 330 g Nitinol wire may have a pull force of 3.3 Newtons, If this wire is configured so as to pull on an element and the element is blocked from movement to a sufficient extent, the Nitinol wire may be capable of exerting a further pull force of, say, 9 Newtons. By this stage, however, the Nitinol wire may be in danger of being damaged. International Patent Application No. PCT/AU2004/001580, the contents of which are imported herein by reference, provides a strain reduction assembly which can be useful. The strain reduction assembly includes:
a material adapted to contract when activated, the material having:
a first pull force at which the material is adapted to move an element to which the material is directly or indirectly connected;
a second pull force greater than the first pull force; and
a third pull force intermediate the first pull force and the second pull force; and
means adapted to be activated when the pull force on the material has reached substantially the third pull force.

The means adapted to be activated when the pull force is substantially the third pull, force may be a compression spring attached to the material.

The material adapted to contract when activated is preferably the Nitinol wire referred to above. The first, second and third pull forces will depend on the rating of the Nitinol wire. By way of example, if the rating is around 3.3 Newtons, this will represent the first pull force. The second pull force in this example will be around 9 Newtons while the third pull force will be around 4.5 Newtons. Ideally, the third pull force is approximately one and a half times greater than the first pull force and calculated to be less than the second pull force, which may be calculated as that capable of causing damage to the material.

The element to be moved by the material adapted to contract such as the Nitinol wire may be any appropriate element. In the context of the present invention the element is the shuttle.

The compression spring is preferably of any suitable construction.

The means adapted to be activated at the third pull force may take other forms. By way of non limiting example, the means may include monitoring resistance in the Nitinol wire and cutting of electrical power once the resistance has changed by, say, twenty percent.

In the case of either embodiment, the Nitinol wire can be protected from damage.

Preferably, the releasable fastening system of the first or second aspect of the invention includes this strain reduction assembly.

As indicated above, the invention in its various aspects has been described in relation to fastening or sealing of panels, hatches or doors or other elements to aircraft. The invention in its various aspects is capable of application to a wide variety of other situations. For example, an aspect of the invention may be used to fix elements such as roof racks to automobiles. Many other applications are possible and will be apparent to one skilled in the art.

### BRIEF DESCRIPTION OF THE DRAWINGS

The invention will now be described in relation to certain non-limiting examples thereof in the accompanying drawings, in which:

FIG. 1 is a plan view of an embodiment of the fastening system according to the first aspect of the invention, in the locked position;

FIG. 2 is a cross-sectional view of the system of FIG. 1, taken along the line A-A of FIG. 1;

FIG. 3 is a cross-sectional elevation of a first embodiment of the second aspect of the invention;

FIG. 4 is a cross-sectional elevation of a second embodiment of the second aspect of the invention;

FIG. 5 is a partial plan view of the embodiment in FIG. 4; and

FIG. 6 shows a detail of one end of an actuation shuttle, including a strain reduction assembly, being an overstress spring.

### DETAILED DESCRIPTION OF THE DRAWINGS

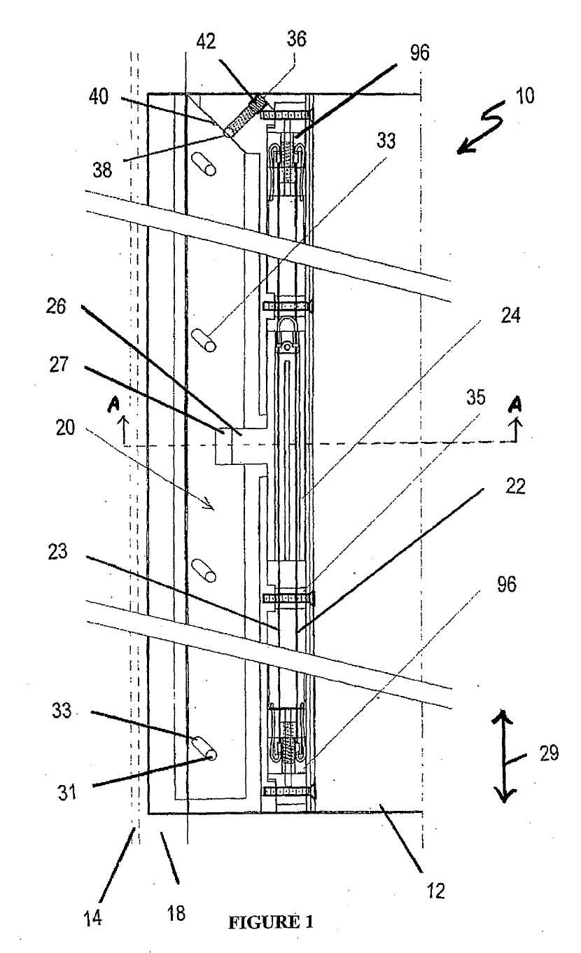

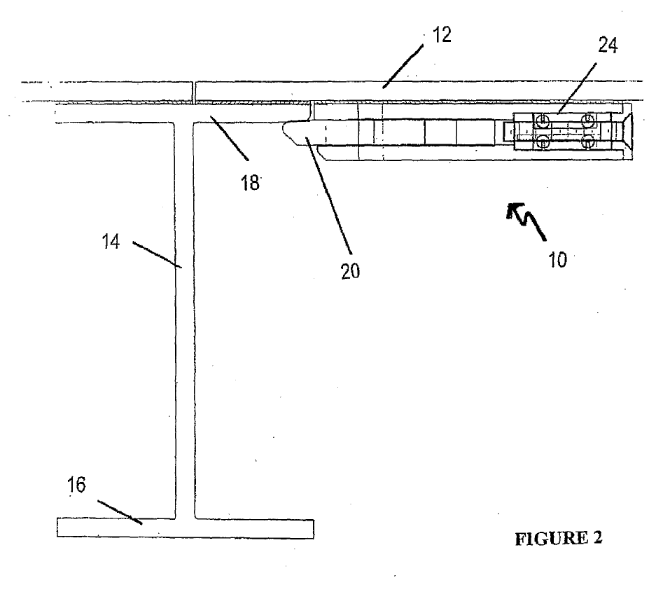

Turning first to FIGS. 1 and 2, fastening system 10 is intended to fasten panel or door 12 to aircraft rib 14. Aircraft rib 14 is shown with an “I” profile and is made of aluminium. However, aircraft rib 14 may be curved, for example at base 16.

As shown in FIG. 2, aircraft rib 14 includes ledge 18. When tongue 20 is in the locked position, it projects under ledge 18 and holds door or panel 12 to aircraft rib 14.

Fastening system 10 is bonded to door or panel 12 by a suitable bonding medium, such as adhesive.

Tongue 20 is shown in FIGS. 1 and 2. Tongue 20 can be drawn back to the unlocked position by activation of shape memory alloy wire 22 in shuttle 24. Activation of shape memory alloy wire 23 in shuttle 24 will reverse tongue 20 so that it is moved to the locked position. Shuttle 24 includes extension 26 which fits into cut out 27 in tongue 20. As shuttle 24 moves along the path indicated by arrow 29, extension 26, engaged in cut out 27, causes tongue 20 to move diagonally, because of guide pins 31 (only one of which is labelled) in diagonal lifting slots 33 (only one labelled). Consequently, the path of tongue 20 is at an angle of about 45° to the path of shuttle 24.

Located at one end of parallel lifting bar 26 is a ball catch locater 36. This is adapted to engage a first depression 38 when tongue 20 is in the locked position and a second depression 40 when tongue 20 is in the unlocked position. Ball catch locater 36 is biased towards parallel lifting bar 26 by spring 42. When tongue 20 is moved positively via shuttle 24, ball catch locater can disengage passively from depression 38 or 40 and spring into depression 40 or 38, as appropriate, without the need for any activation.

Shuttle 24 includes guide 35 for shape memory alloy wires 22 and 23. At each end of shuttle 24 is a fixed end 96, discussed below in FIG. 6.

As can be seen from FIG. 1, door or panel 12 can be of any desired length (indicated by break lines) and fastening system 10 may be of the same length as door or panel 12.

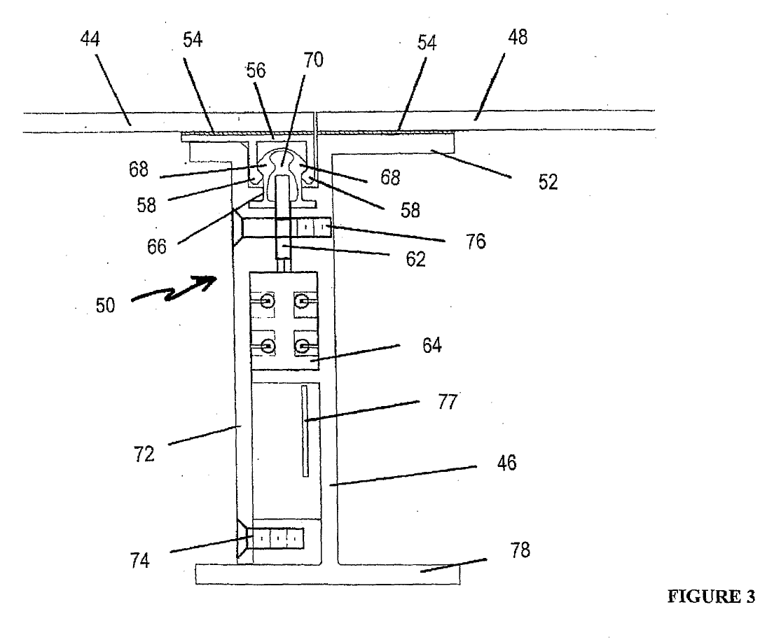

Referring now to FIG. 3, this illustrates how the releasable fastening system in the second aspect of the invention releasably fastens a panel to an aircraft rib. In the drawing, the first element is panel 44 and the second element is rib 46. Releasable fastening system 50 enables panel 44 to be fastened to or released from rib 46 and to be aligned with neighbouring panel 48, which is fixed to ledge 52 of rib 46 by adhesive 54.

Releasable fastening system 50 has first fastening means 56 in the form of a female clamp strip including beads 58. First fastening means 56 is fixed to panel 44 by adhesive 54.

The second fastening means is represented by lifting bar 62 and seal 66. Lifting bar 62 is caused to move towards or away from panel 44 by shuttle 64. As can be seen in FIG. 3, continuous male seal 66 has two thickened or bead-like portions 68 which can fit above beads 58 of first fastening means 56. When lifting bar 62 is caused to move towards panel 44 by shuttle 64, lifting bar 62 enters gap 70 between bead-like portions 68 and locks male seal 66 to first fastening means 56.

It will be appreciated that the interference between male seal 66 and beads 58 of first fastening means 56 can form a hermetic seal between first fastening means 56 and second fastening means 60 and hence between panel 44 and rib 46. This can have decided advantages in aircraft and other manufacture.

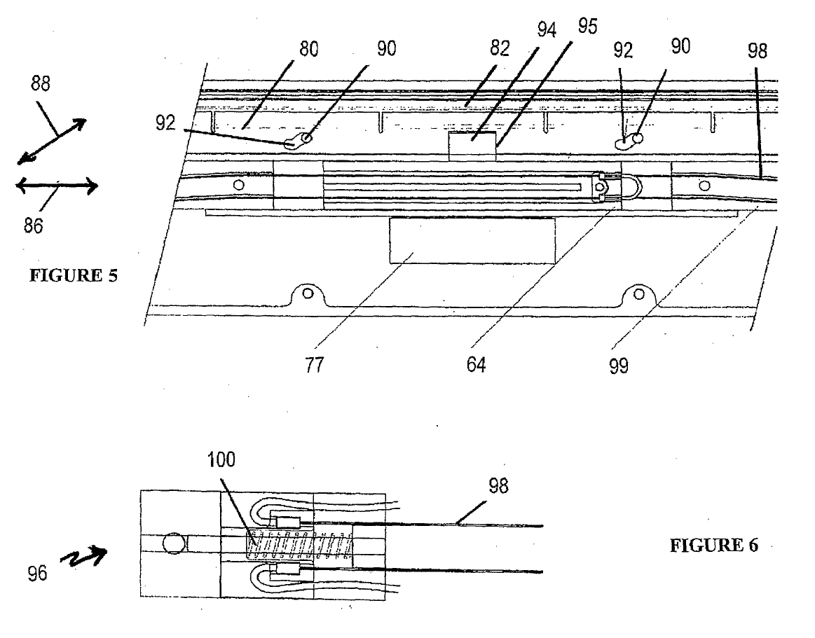

Shuttle 64 in this embodiment is activated by shape memory alloy wire (refer FIGS. 5 and 6). However, shuttle 64 may be any appropriate push-pull actuator operating along a path which is perpendicular to that along which lifting bar 62 moves.

In this embodiment, the second fastening means (lifting bar 62, seal 66) is held to rib 46 by being enclosed under rib lid 72, using screws or other fixing devices 74 and 76. Screw 76 also acts as a guide pin in this embodiment.

Because shuttle 64 in this embodiment uses shape memory wire actuation, electronics printed wire assembly 77 is included to control actuation.

Although rib 46 is shown with a flat base 78 in this embodiment, it will be appreciated that rib base 78 could be curved, as could panels 44 and 48, for example.

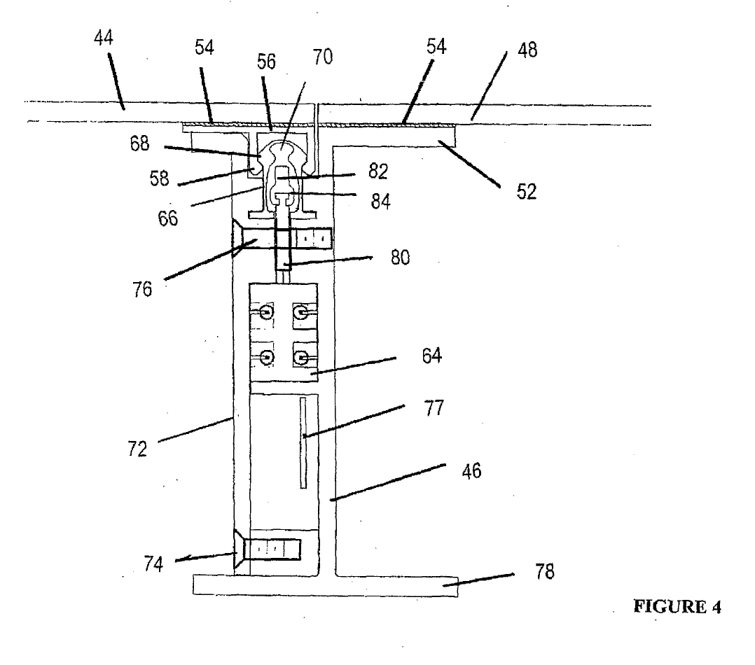

The sealing of the fastening system of the invention may be continuous in a linear configuration, as in the embodiment in FIG. 3, or continuous in a non-linear figuration, as in the embodiment in FIG. 4, which will now be described. Many of the parts in the FIG. 4 embodiment are the same as those in the FIG. 3 embodiment and the same numbers will be used.

In FIG. 4, the second fastening means includes not only lifting bar 80 but also continuous locking bar 82. Lifting bar 80 terminates in a T-shaped end and continuous locking bar 82 has a complementary T-shaped cavity 84, so that continuous locking bar 82 forms a slip joint with lifting bar 80. When shuttle 64 is actuated to fasten panel 44 to rib 46, it moves lifting bar 80 towards panel 44.

Lifting bar 80 follows a somewhat diagonal path when viewed in plan. The diagonal movement of lifting bar 80 can be seen from FIG. 5. As shuttle 64 moves in the direction of arrow 86 through contraction of shape memory alloy wire 98, through guide 99, lifting bar 80 is caused to move in the direction of arrow 88, by reason of movement of guide pins 90 in diagonal lifting slots 92, and engagement of shuttle extension 94 in cut out 95 of lifting bar 80, in a similar manner to that described in connection with the embodiment in FIGS. 1 and 2.

At each end of shuttle 64 is a fixed end 96. One of these is shown in more detail in FIG. 6. Shape memory alloy wire 98 contracts when activated to draw shuttle 64 to the right or the left of FIG. 5, as required to move lifting bar 80 along the path represented by arrow 86. Fixed end 96 includes a strain reduction assembly to prevent damage of shape memory wire 98 should there be any jamming of shuttle 64. If the normal pull force for shape memory alloy wire 98 is exceeded by approximately 1½ times, compression spring 100 is designed to activate to reduce strain on the shape memory alloy wire 98. Compression spring 100 relieves strain on shape memory alloy wire 98, should it be unable to draw shuttle 64 in the desired direction.

### INDUSTRIAL APPLICABILITY

As will be readily appreciated by those skilled in the various arts, the invention disclosed herein is not limited to the examples set out and has wide application in many areas. The invention represents a significant advance in the art of securing and releasing, particularly in connection with aircraft panels, hatches and doors.

1. A releasable fastening system including:
a tongue moveable along a first path between a locking position and an unlocking position;
a shuttle moveable along a second path at an angle to the first path, the shuttle being adapted to be moved along the second path by material adapted to contract when activated; and
means linking the tongue and the shuttle such that movement of the shuttle along the second path is adapted to cause movement of the tongue along the first path.

2. The releasable fastening system of claim 1, wherein the shuttle is made of Nylon or Acetal.

3. The releasable fastening system of claim 1, wherein the material adapted to contract when activated is shape memory alloy wire.

4. The releasable fastening system of any one of claims 1, wherein the linking means is an extension from the shuttle, the extension lying in a plane which is perpendicular to the second path.

5. The releasable fastening system of claim 4, wherein the extension is adapted to fit into a corresponding cutout in the tongue and to be sliceable therein.

6. The releasable fastening system of claim 5, wherein the tongue is constrained by guide pins in diagonal slots to move at an angle of approximately 45 degree to the second path.

7. A releasable fastening system for releasably fastening a first element to a second element, the releasable fastening system including:
a first fastening means for the first element;
a second fastening means for the second element, the second fastening means being movable along a first path between a locking position in which the second fastening means engages the first fastening means and an unlocking position in which the second fastening means is disengaged from the first fastening means;
a shuttle movable along a second path at an angle to the first path; and
means linking the second fastening means and the shuttle such that movement of the shuttle along the second path is adapted to cause movement of the second fastening means along the first path.

8. The releasable fastening system of claim 7, wherein the first element is a panel or door.

9. The releasable fastening system of claim 7, wherein the second element is a rib.

10. The releasable fastening system of any one of claim 7, wherein the first fastening means is attached to the first element by adhesive or in another suitable manner.

11. The releasable fastening system of any one of claim 7, wherein the second fastening means is attached to or integral with the second element.

12. The releasable fastening system of any one of claim 7, wherein the shuttle is adapted to be moved along the second path by material adapted to contract when activated.

13. The releasable fastening system of claim 12, wherein the material adapted to contract when activated is shape memory alloy wire.

14. The releasable fastening system of any one of claim 7, wherein the second fastening means includes a lifting bar constrained to move along the first path by one or more guide pins in diagonal lifting slots.

15. The releasable fastening system of any one of claim 7, wherein the first path is at an angle of about 45° to the second path.

16. The releasable fastening system of any one of claim 7, wherein the linking means is an extension from the shuttle, the extension lying in a plane which is perpendicular to the second path.

17. The releasable fastening system of any one of claim 7, wherein the second fastening means includes a seal which, together with the first fastening means, is capable of hermetically sealing the fastening system.

18. The releasable fastening system of any one of claim 7, which includes a slip joint as part of the second fastening means.

19. The releasable fastening system of any one of claim 12, which includes means for protecting the material adapted to contact when activated from damage.

20. The releasable fastening system of any one of claim 1, which includes a strain reduction assembly including:
a material adapted to contract when activated, the material having:
a first pull force at which the material is adapted to move an element to which the material is directly or indirectly connected;
a second pull force greater than the first pull force; and
a third pull force intermediate the first pull force and the second pull force; and
means adapted to be activated when the pull force on the material has reached substantially the third pull force.

21. The releasable fastening system of claim 20, wherein the means is a compression spring attached to the material.

22. The releasable fastening system of claim 20, wherein the means is adapted to monitor resistance in the material wire and cut electrical power.

23. (canceled)

24. The releasable fastening system of any one of claim 1, which includes a strain reduction assembly including:
a material adapted to contract when activated, the material having:
a first pull force at which the material is adapted to move an element to which the material is directly or indirectly connected;
a second pull force greater than the first pull force; and
a third pull force intermediate the first pull force and the second pull force; and
means adapted to be activated when the pull force on the material has reached substantially the third pull force.

25. The releasable fastening system of claim 24, wherein the means is a compression spring attached to the material.

26. The releasable fastening system of claim 25, wherein the means is adapted to monitor resistance in the material wire and cut electrical power.
